(19) United States
(12) Patent Application Publication
(10) Pub. No.: US 2006/0200302 A1
(43) Pub. Date: Sep. 7, 2006

(54) Navigation system

(75) Inventor: Shigeyuki Seko, Campbell, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Twin Communications of America, Inc., San Jose, CA (US)

(21) Appl. No.: 11/073,410

(22) Filed: Mar. 4, 2005

(51) Int. Cl. G01C 21/00

(52) U.S. Cl. 701/200; 701/211; 340/995.1

(57) ABSTRACT

Techniques for a navigation system realizing a large cost reduction and speedy on-demand functions of a portable terminal device are provided. In an embodiment of the present invention, a navigation system comprises a navigation terminal 3 for downloading and displaying information and a content server 1 for transmitting content generated based on position information of the navigation terminal 3 to the navigation terminal 3. The various applications and services delivered with the navigation terminal 3 utilize XOE 30 through the content server 1. As well as enhancing applications of the client terminal 3, starting a completely new service can be easily realized. Building a system into the XOE 30 in advance to deliver the new service through the content server 1 is not necessary. With the XOE 30, a favorite service can be started at any time without any preparations.

### CROSS-REFERENCES TO RELATED APPLICATIONS

Not applicable

### BACKGROUND OF THE INVENTION

The present invention relates to a navigation system, which displays information.

The navigation systems in which map data being recorded in a recording medium such as a CD-ROM device, a DVD-ROM device or a hard disc device are read out and the read out information is displayed are known (see, for example, Patent Document 1). Some of the systems display a calculated coordinate and traveling direction on a map, and other systems display information on roadside shops and facilities and weather information in addition to the coordinate and direction (see, for example, Patent Document 2).

Furthermore, a navigation terminal comprises specific hardware (such as CPU) and a specific OS (operating system), for which a processing program is often described in C language or assembler. For this reason, to maintain compatibility on change of map information, some navigation systems read out the map information to be stored in a navigation terminal from a recording medium and provide it even in the case of being described in a processing program dependent on the specific hardware and OS (see, for example, Patent Document 3).

However, because the capacity of a client-side recording medium such as a CD-ROM device, a DVD-ROM device or a hard disc device is limited, some navigation systems can be operated without recording information such as map information in the recording medium such as the above-described CD-ROM to reduce the load on the recording medium (see, for example, Patent Document 4).

Some of such navigation systems are operated in such a way that a request including information on departing and arrival points and client identifying information specific to a navigation client is transmitted from the client to a server through a communication network and then a routing assistant information program generated in a JAVA (registered trademark) applet format based on the request is transmitted from the server back to the client (see, for example, Patent Document 5).

Details describing conventional navigation systems can be found in the following documents:

Patent Document 1: Japanese unexamined patent application No. H02-129800;

Patent Document 2: Japanese unexamined patent application No. 2002-148061;

Patent Document 3: Japanese unexamined patent application No. H11-230767;

Patent Document 4: Japanese unexamined patent application No. 2002-163550; and

Patent Document 5: Japanese unexamined patent application No. 2003-240563.

Even employing the techniques described in the above Patent Documents 1 to 5, many problems still remain, such as mobility to a different architecture, service extensibility, multiclient integrity, and installability of new contents through a network.

In particular, because existing portable devices employ the Windows CE (registered trademark) that is premised on the utilization with expensive desktop PCs or the Palm OS (registered trademark) that is less extensible because of being customized for specific models, the realization of a compact-sized program is difficult in design.

Furthermore, employing the techniques described in the above Patent Documents 4 and 5, a navigation terminal can be used in a cross-platform environment such as JAVA (registered trademark); however, even in such a case, inconvenience tends to take place during image processing and the like in the navigation terminal with a limited memory capacity because a portable terminal device itself including the navigation terminal uses most of the memory capacity. For this reason, in many cases, a client's inquiry or request of a new content cannot be promptly responded

The present invention is made in consideration of the above situation and realizes a large cost reduction while realizing speedy on-demand functions of a portable terminal device.

### BRIEF SUMMARY OF THE INVENTION

To achieve the above object, a navigation system of the present invention is comprised of a navigation terminal for downloading and displaying information and a server for transmitting content generated based on position information of the navigation terminal to the navigation terminal, wherein the server is comprised of: information receiving means for receiving an input of the position information from the navigation terminal through a network; moving direction prediction means for predicting the succeeding moving direction of the navigation terminal based on the input position information; map information generating means for generating map information based on the predicted information; and information delivery means for delivering the generated map information through the network, the navigation terminal comprises: receiving means for receiving the delivered information; processing means for processing the received information using an application loaded on the navigation terminal; display means for displaying the processed information; and transmitting means for transmitting the position information of the navigation terminal to the information receiving means when the navigation terminal has moved, the processing means comprises: data synchronizing means for synchronizing data to be delivered from the information delivery means with the receiving means of the navigation terminal; and package management means for executing a plurality of preset functions without the use of software on a platform, and the plurality of functions are executed after downloading the received information to be processed by the processing means whenever position information of the navigation terminal changes.

The navigation system may be characterized in that information generated by the map information generating means includes information on traffic, restaurant, accommodation, shop, weather, parking and news in addition to the map information.

The navigation system may be characterized in that the package management means downloads information to execute an appropriate function from the server at the request of a new service and then installs an application capable of providing the new service on the navigation terminal.

The navigation system may be characterized in that the server comprises a database storing a plurality of applications to be sent to the navigation terminal upon the request of the navigation terminal.

The navigation system may be characterized in that the moving direction prediction means divides adjacent map information into a plurality of blocks based on the information that the information receiving means has received and the processing means of the navigation terminal downloads only information on blocks in a moving direction of the navigation terminal.

The navigation system may be characterized in that the moving direction prediction means divides adjacent map information into nine blocks and the processing means of the navigation terminal downloads only information on five blocks in the moving direction of the navigation terminal.

The navigation system may be characterized in that none of a CD-ROM device, a DVD-ROM device and a hard disc device is loaded into the navigation terminal.

The navigation system may be characterized in that the navigation terminal executes an emergency program in case that a vehicle equipped with the navigation terminal is stolen and the server predicts the succeeding moving direction by the moving direction prediction means based on position information of the navigation terminal and comprises security means for alerting the police.

According to the navigation system of the present invention, a plurality of the packaged functions that process large-volume data such as map information and image information can be executed on a variety of OSs or software without the use of a large-capacity storage device.

Various additional objects, features and advantages of the present invention can be more fully appreciated with reference to the detailed description and accompanying drawings that follow.

### BRIEF DESCRIPTION OF THE DRAWINGS

FIG. 1 is a simplified, conceptual diagram of a navigation system according to an embodiment of the present invention.

FIG. 2 is a simplified block diagram of the client terminal 3 shown in FIG. 1, according to an embodiment of the present invention.

FIG. 3 is a simplified block diagram of the XOE application loaded onto the client terminal 3, according to an embodiment of the present invention.

FIG. 4 is another simplified block diagram of the client terminal loaded with the XOE application, according to an embodiment of the present invention.

FIG. 5 is a simplified block diagram showing a local service function and a package management function of the XOE 30, according to an embodiment of the present invention.

FIG. 6 is a simplified block diagram of the database 7 shown in FIG. 2, according to an embodiment of the present invention.

FIG. 7 is a simplified diagram for describing the effect of the navigation system according to the embodiment of the present invention, according to an embodiment of the present invention.

FIG. 8 is an explanatory diagram for the case of using the navigation system according to the embodiment of the present invention as car navigation equipment, according to an embodiment of the present invention.

FIG. 9 is a simplified diagram showing a moving direction of the mobile object 2 shown in FIG. 8, according to an embodiment of the present invention.

FIG. 10 is a simplified diagram for describing a navigation process for the moving direction of the mobile object 2 shown in FIG. 9, according to an embodiment of the present invention.

FIG. 11 is a simplified second diagram for describing a navigation process for the moving direction of the mobile object 2 shown in FIG. 9, according to an embodiment of the present invention.

FIG. 12 is a simplified third diagram for describing a navigation process for the moving direction of the mobile object 2 shown in FIG. 9, according to an embodiment of the present invention.

FIG. 13 is a simplified fourth diagram for describing a navigation process for the moving direction of the mobile object 2 shown in FIG. 9, according to an embodiment of the present invention.

### DETAILED DESCRIPTION OF THE INVENTION

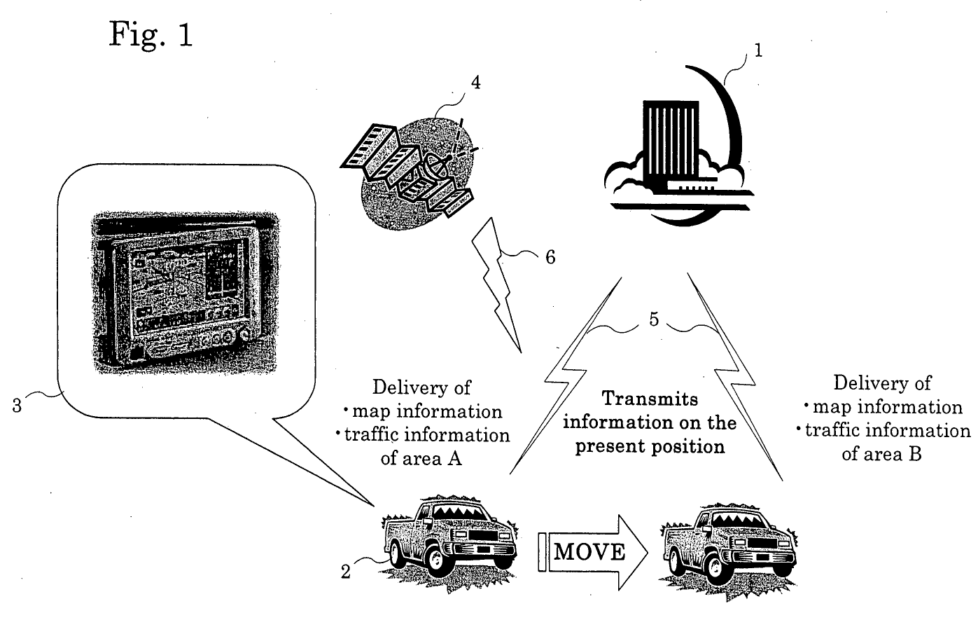

FIG. 1 is a conceptual diagram of a navigation system according to an embodiment of the present invention. As shown in the diagram, the navigation system according to the embodiment of the present invention is composed of a content server 1, a mobile object 2, a client terminal 3, a GPS (Global Positioning System) satellite 4, a network 5 and a GPS network 6.

In the navigation system of the embodiment, the content server 1 stores information in various databases and transmits stored information after processing the stored information while communicating information with the various databases. The server also connects to a plurality of mobile objects through the network and provides a navigation system by communicating navigation information with each of the mobile objects.

The mobile object 2 is, for example, a vehicle or the like. The mobile object 2 communicates information with the content server 1 through the client terminal 3 while moving every second. The mobile object 2 may be an airplane, a ship, a bicycle, a person, a cart in a shopping center, or the like besides a vehicle.

The client terminal 3 is the portable terminal device onto which the software called XOE, as will be described below, is loaded. The client terminal 3 comprises specific hardware (such as CPU) and a specific OS, for which a processing program is described in C language or assembler. The client terminal 3 may be the navigation terminal or the like which various existing manufacturers sell and onto which the XOE is loaded. By loading the XOE, a system without the use of a CD-ROM device, a DVD-ROM device or a hard disc device can be established while realizing on-demand functions.

The GPS satellite 4 is approximately 20000 km above the earth. A GPS measurement is carried out by utilizing an electric wave being transmitted from the satellite. The number of the satellites composing the GPS may be one or more and each of a plurality of the satellites may be arranged on the orbital plane having a predetermined orbital inclination.

As the network 5, the Internet is assumed; however, it may be a network such as LAN (Local Area Network). It may also be a packet data communication in data transmission utilizing a cellular phone network such as GSM (Global System for Mobile Communications) or GPRS (General Packet Radio Service). The network 6 is the GPS communication network utilizing the GPS satellite 4.

In FIG. 1, the mobile object 2 in the area A confirms the information on the present position of the mobile object 2 with the GPS satellite 4 through the network 6. Subsequently, the mobile object 2 transmits the data that have been processed based on the information received from the GPS satellite 4 to the content server 1 through the network 5 and then receives map information and traffic information from the content server 1 through the network 5. Then, when the mobile object 2 has moved to the area B, the mobile object 2 again confirms information on the position of it with the GPS satellite 4 through the network 6. Subsequently, the mobile object 2 transmits the data that have been processed based on the information received from the GPS satellite 4 to the content server 1 through the network 5 and then receives necessary map information and traffic information from the content server 1 through the network 5.

In the navigation system according to the embodiment, the software called XOE is loaded onto the client terminal 3. Using the XOE, a plurality of the packaged functions that process large-volume data such as maps and images can be executed on a portable device terminal operable with a variety of existing OSs or software without the use of a large-capacity storage device. In the navigation system according to the embodiment, various functions to be described below can be promptly realized at a low cost because the client terminal 3 loaded with the XOE is employed.

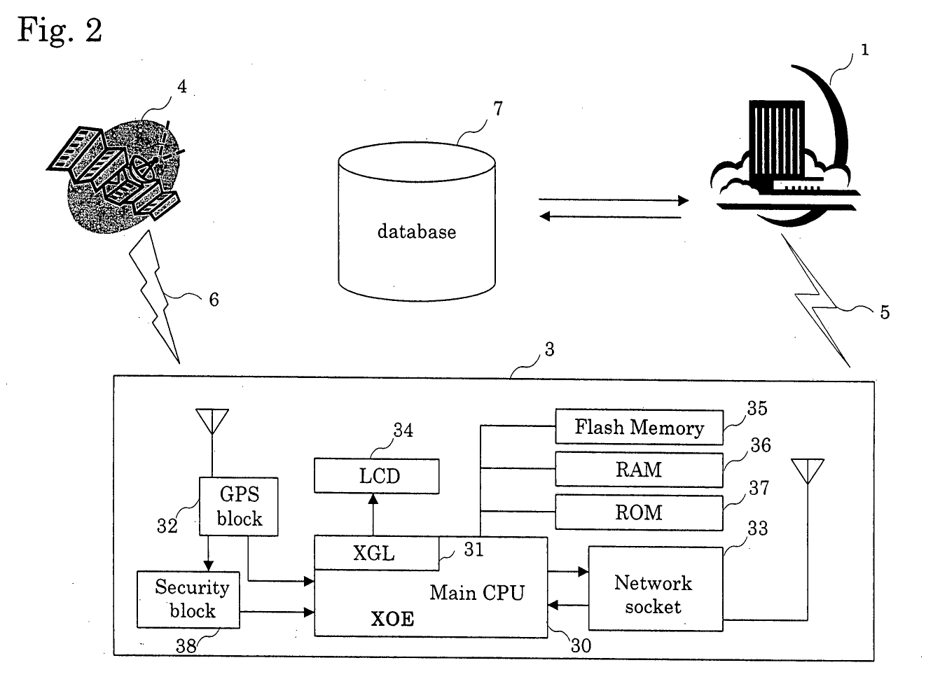

FIG. 2 is a block diagram of the client terminal 3 shown in FIG. 1. The client terminal 3 communicates data with the GPS satellite 4 through the network 6 and with the content server 1 through the network 5. Then, upon the request of the client terminal 3, the content server 1 accesses the database 7 to obtain necessary information and then transmits it to the client terminal 3 through the network 5

To realize the navigation system, the database 7 is composed of a plurality of databases such as databases of map information, traffic information, parking information and restaurant information, all of which are not shown. In the embodiment, the database 7 is composed of, but not limited to, a database group including lower-level databases.

The client terminal 3 is composed of XOE 30, XGL 31, a GPS block 32, a network socket 33, an LCD 34, a flash memory 35, a RAM 36, a ROM 37 and a security block 38. The XOE 30 is a processing part including XOE software and a main CPU, and is processing means for processing information received from the content server 1 and the GPS satellite 4 using loaded applications. Because the XOE 30 realizes a compact-sized program, i.e. approximately 1/10 in size of the Windows CE (registered trademark), a storage device such as a CD-ROM device, a DVD-ROM device or a hard disc device is not necessary to execute the XOE 30 whereas it can be executed with only the use of a semiconductor memory. In addition, the XOE software may be stored in the ROM 37.

The XGL 31 is a graphic library for the XOE 30. By using the XGL 31, the beautiful color graphics can be realized although the program size of the XOE is small. Map data can be beautifully and expressively displayed, particularly in a car navigation system.

A package management function, which is to be described below, of the XOE 30 allows to deliver various applications and services through the content server 1. As well as enhancing applications of the client terminal 3, starting a completely new service can be easily realized. Also, building a system into the XOE in advance to deliver the new service through the content server 1 is not necessary. With the XOE 30, a favorite service can be started at any time without any preparations.

The GPS block 32 is a network block for receiving data from the GPS satellite 4 through the network 6. The GPS block 32 comprises a GPS antenna and a power-saving GPS chip and is also a communication block included emergency situations such as a car burglar. The network socket 33 is for wireless communications, which carries out a packet data communication while utilizing a cellular phone network such as GSM or GPRS. The network socket 33 is also a communication block including a GSM antenna and a GSM unit.

The LCD 34 is a display using TFTs (Thin Film Transistors), STN-LC (Super Twisted Nematic Liquid Crystal), organic EL (Electro Luminescence), or the like. The flash memory 35, RAM 36 and ROM 37 are the semiconductor memories with which the XOE 30 processes information received from the content server 1 and the GPS satellite 4. The client terminal 3 according to the embodiment employs only the semiconductor memories such as the flash memory 35, the RAM 36 and the ROM 37, but not a large-capacity recording medium such as a CD-ROM device, a DVD-ROM device or a hard disc device.

The use of the XOE 30 can eliminate the use of a large-capacity recording medium such as a hard disc device, which leads to some advantages such as a low cost, the improvement of reliability due to fewer malfunctions even in the in-vehicle equipment that very often vibrates, and a simple setup due to a downsized main body. Also, a magnetic recording device is not suitable for in-vehicle equipment because a large magnetic field is sometimes generated due to the presence of many high-voltage parts in the in-vehicle equipment; however, only the use of semiconductor memories allow to eliminate such a disadvantage.

In case that the mobile object 2 equipped with the client terminal 3 is stolen, the security block 38 executes a security function in such a way that after starting up an emergency program, the security block 38 transmits position information of the client terminal 3 to the content server 1, predicts a moving direction and alerts the succeeding moving direction to the police. The security block 38 can accesses the GPS satellite 4 through the GPS block 32 and downloads necessary information from the content server 1 to alert the police. The security block 38 may be built in as the software that is one of the packaged functions of the XOE.

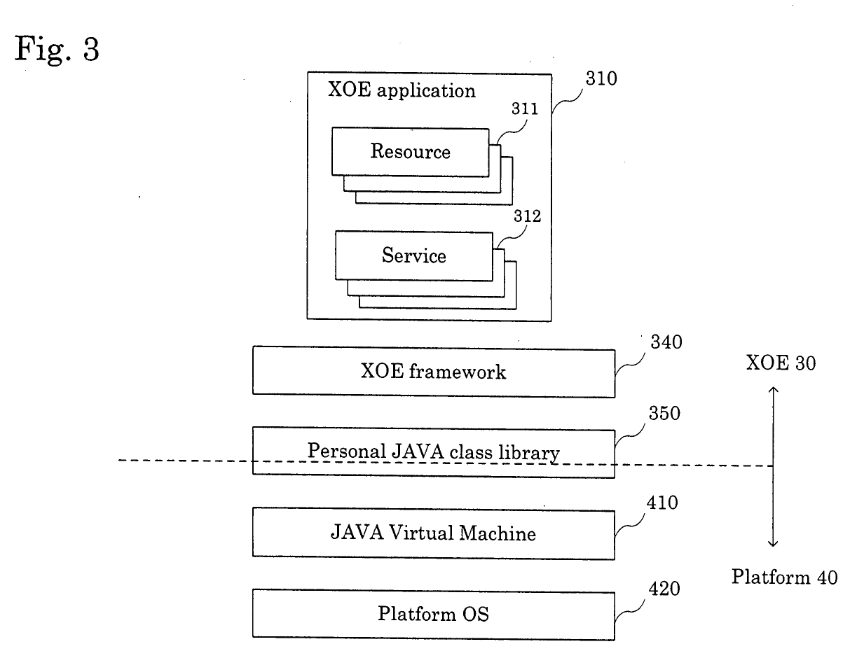

FIG. 3 is a block diagram of the XOE application loaded onto the client terminal 3. The diagram is also a conceptual diagram showing an OS of a platform 40 loaded with the XOE 30, JAVA (registered trademark) and the XOE application 31 0.The XOE 30 is loaded on the platform OS 420 and Java (registered trademark) Virtual Machine 410 as a personal JAVA (registered trademark) class library 350. A XOE framework 340 is configured to maintain independence of the platform OS 420 and the JAVA (registered trademark) Virtual Machine 410.

Next, a configuration of the XOE application 310, which is the core of the present invention, will be described. The XOE application is the application that can execute a plurality of the packaged functions that process large-volume data such as maps and images on a wide variety of OS's and software without the use of a large-capacity storage device. In particular, the XOE application 310 is configured as shown in FIG. 3, operated on a JAVA (registered trademark) runtime and comprised of one or more documents described in XHTML or the like and a servlet including a certain kind of logic.

The XOE application 310 is comprised of Resource 311 and Service 312 and the Resource 311 includes one or more XHTML or XML including a view specification and static display data. The Service 312 of the XOE application 310 is comprised of a servlet including both control event and form action logics.

Such a configuration as described above allows dealing with any new language and document format. The XOE 30 is also configured to realize both the independence of the OS of the platform 40 and the compatibility of a Java (registered trademark) applet.

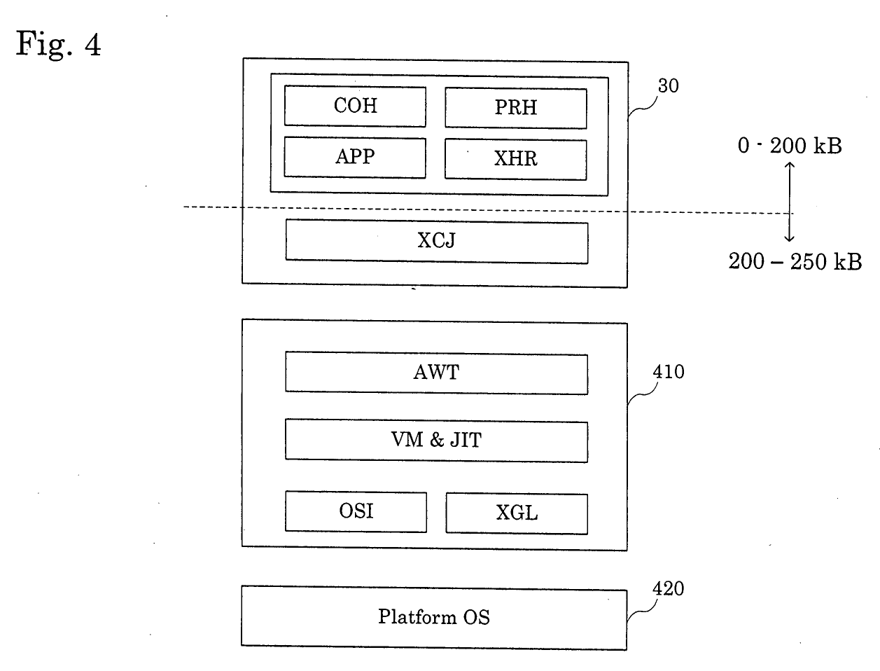

FIG. 4 is another block diagram of the client terminal 3 loaded with the XOE application 310. The XOE 30 is comprised of COH, PRH, APP, XHR and XCJ as shown in FIG. 4.

The COH (Content Handler) is a content processing circuit, the PRH a protocol processing circuit, the APP (Application) a JAVA application and the XHR (xHTML Renderer) an xHTML renderer engine.

The XCJ (XOE-Core. Jar) is the core of the XOE described in JAVA and AWT (Abstract Windowing Toolkit) is a tool to use graphics from JAVA.

VM & JIT is the JAVA Virtual Machine and OSI (OS Interface) is an interface for the OS.

The XGL is a compact-sized graphic library, which is realized with 64 k bytes in size in the embodiment although the size needed is usually 1 M bytes.

In the XOE 30, the occupied capacity for the COH, PRH, APP and XHR is less than 200 k bytes whereas the XCJ needs a capacity of 200˜250 k bytes as shown in FIG. 4. Another effect of the use of the XOE 30 is to realize various services with an extremely small capacity.

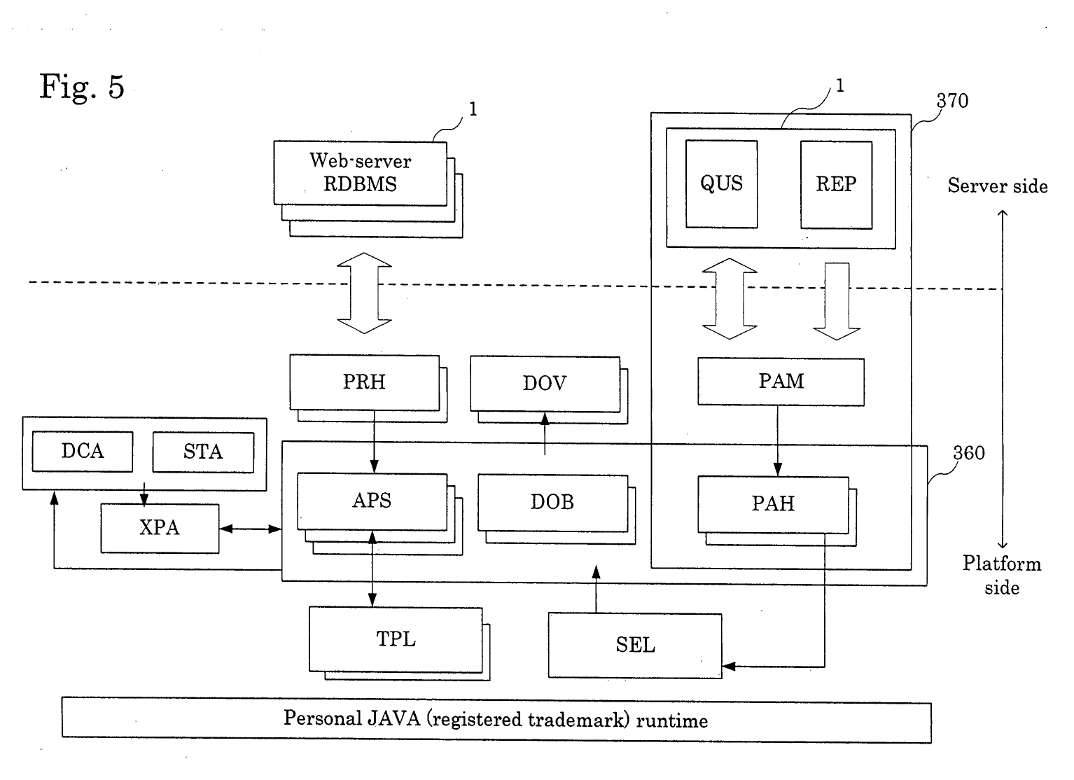

FIG. 5 is a block diagram showing a local service function and a package management function of the XOE 30. In this diagram, information communication between the content server and the client terminal loaded with the XOE application is described. The client terminal operates on the JAVA (registered trademark) runtime and is composed of a local service functional part and a package management functional part.

One of the main features of the XOE is realized with the local service and package management functions. Various services are provided to a user of the client terminal 3 by executing these two functions and downloading sequentially a verity of information from the content server 1. Furthermore, because, in the client terminal 3, a system without the use of a recording medium such as a CD-ROM device, a DVD-ROM device or a hard disc device can be established while realizing on-demand functions, a large cost reduction of the client terminal can be realized.

The XOE 30 comprises the local service and package management functional part 360 and the package management functional part 370. The local service functional part 360 functions as a backbone of the XOE structure and is composed of APS (Application Servlet), DOB (Document Builder) and PAH (Package Handler).

The APS (Application Servlet) is a JAVA application servlet, the DOB (Document Builder) generates an XML document and the PAH (Package Handler) operates each package of the package management function.

TPL (3rd Party Library) is a library for a third party, SEL (Service Locator) is a locator for each package of the package management function, PAM (Package Manager) manages the package management function, PAS (Package Server) is a server for each package of the package management function, QUS (Query System) expresses a processing request (query) to a database management system as character strings (such as SQL), and REP (Repository) is a container for specific registration information being distributed.

DCS (DOM based Content System) is a document object model and an application interface for HTML and XML documents, which defines a logical structure of a document and a method for accessing and operating a document. DOC (Document Cache) is a cache for temporarily storing the above documents. STA (Stash) is a file system for the XOE.

The package management functional part 360 and the package management functional part 370 of the XOE comprising the above structure operate on the Personal JAVA (registered trademark) runtime and deliver various contents with the content server 1. As well as enhancing applications of the client terminal 3, starting a completely new service can be easily realized. Building a system into the XOE in advance to deliver the new service through the content server 1 is not necessary.

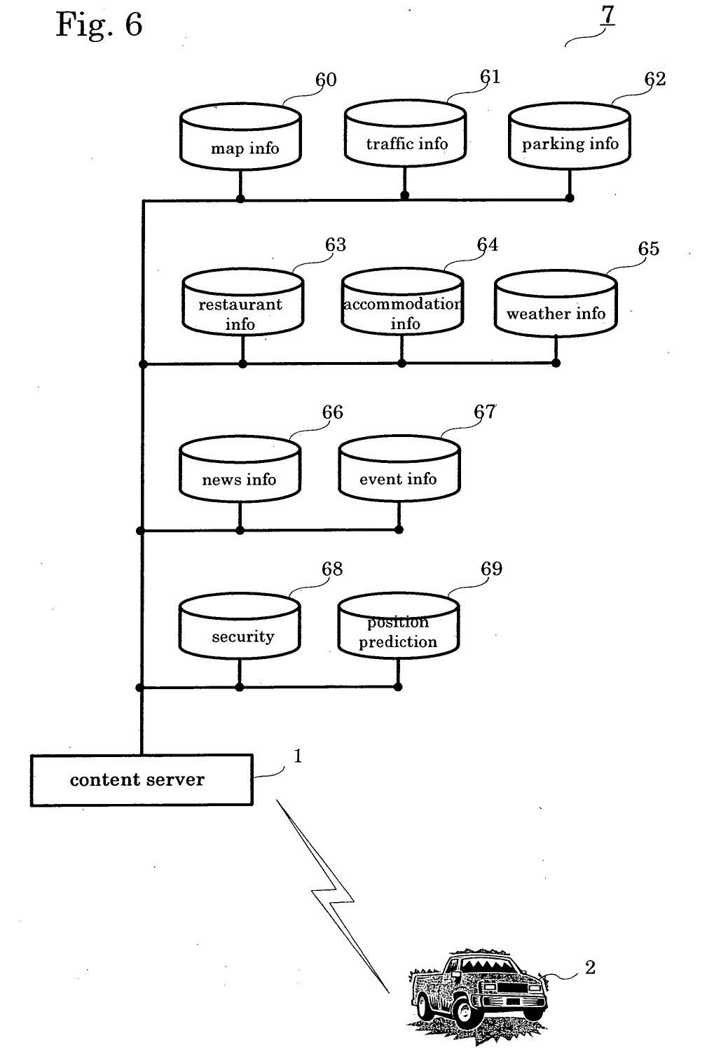

FIG. 6 is a block diagram of the database 7 shown in FIG. 2. The database 7 is, but not limited to, a database group comprised of a plurality of databases, and is composed of the map information database 60, traffic information database 61, parking information database 62, restaurant information database 63, accommodation information database 64, weather information database 65, news information database 66, event information database 67, security database 68 and position information prediction database 69. Each of these databases 60 to 69 is also composed as, but not limited to, the higher-level database group that is comprised of a plurality of lower-level databases.

The map information database 60 is a database for storing map information to be transmitted to the navigation system. The map information is configured to deal with a three-dimensional color display and the like. The traffic information database 61 is a database for storing traffic information around a selected map. The traffic information is configured to be updated with the change in information.

The parking information database 62 is a database for storing a variety of parking information such as availability of a parking lot, parking fees and opening hours. The restaurant information database 63 is a database for storing a variety of information such as restaurant search, reservation information and approximate expenses. The accommodation information database 64 is a database for storing a variety of information such as addresses of accommodations, information on room availability, accommodation rates, and telephone numbers.

The weather information database 65 is a database for storing weather information received from the Meteorological Agency. The weather information is configured to be updated with the change in weather.

The news information database 66 is a database for storing a variety of news information such as politics, business, entertainment and shopping. The event information database 67 is a database for storing a variety of event information such as sports, concerts, movies and travel.

The security database 68 is a database for storing security information to alert the police, in case that the mobile object 2 equipped with the client terminal 3 is stolen, in such a way that after starting up an emergency program, a moving direction is predicted based on position information from the client terminal 3 and then it is alerted to the police. In case that the mobile object 2 equipped with the client terminal 3 is stolen, the security block 38 shown in FIG. 2 executes a security function in such a way that after starting up an emergency program, the security block 38 transmits position information of the client terminal 3 to the content server1, predicts the succeeding moving direction and alerts it to the police. The security database 68 stores information to transmit the emergency program to the client terminal 3 and information to alert the nearest police.

The position information prediction database 69 stores the information with which the client terminal 3 can predict the succeeding moving direction based on the position information the content server 1 has received.

These databases comprises, on the side of the content server 1, map information generating means, moving direction prediction means and security means, whereby the read-write operation of information in the database 7 is carried out and necessary information is generated. For example, based on the position information the content server 1 has received, the moving direction prediction means predicts the succeeding moving direction of the client terminal 3 by using information in the position information prediction database 69 and then transmits it to the client terminal 3. In addition, the content server 1 comprises an information transmitting and receiving part, which is not shown.

Furthermore, the content server 1 is not necessarily provided with the map information generating means, the moving direction prediction means and the security means; but the client terminal 3 may be provided with them. In the embodiment, to downsize the client terminal 3, the content server 1 is provided with the map information generating means, the moving direction prediction means and the security means.

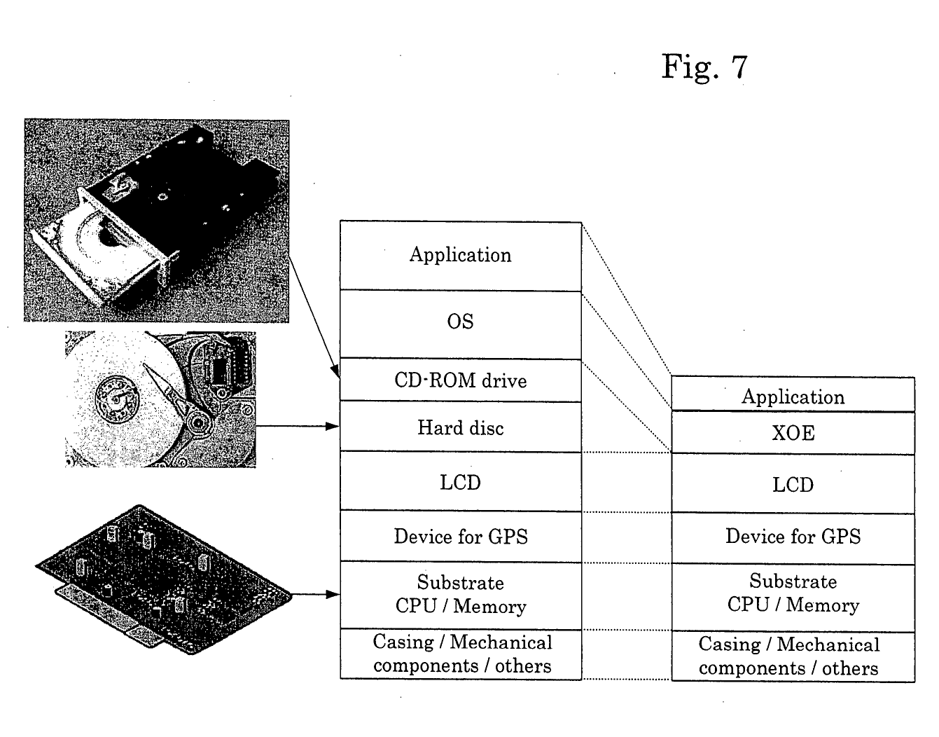

FIG. 7 is a diagram for describing the effect of the navigation system according to the embodiment of the present invention. The client terminal 3 is loaded with the XOE 30 and realizes the on-demand using the network 5. Because building a system without the use of a hard disc and a CD-ROM on the side of the client terminal 3 becomes possible, a large cost reduction of a terminal can be realized.

In particular, loading the XOE 30 allows reducing an application itself and an OS of the client terminal 3 is not indispensable as shown in the diagram. The hard disc and the CD-ROM are completely eliminated. For this reason, a cost reduction of $100 or more per one client terminal 3 becomes possible.

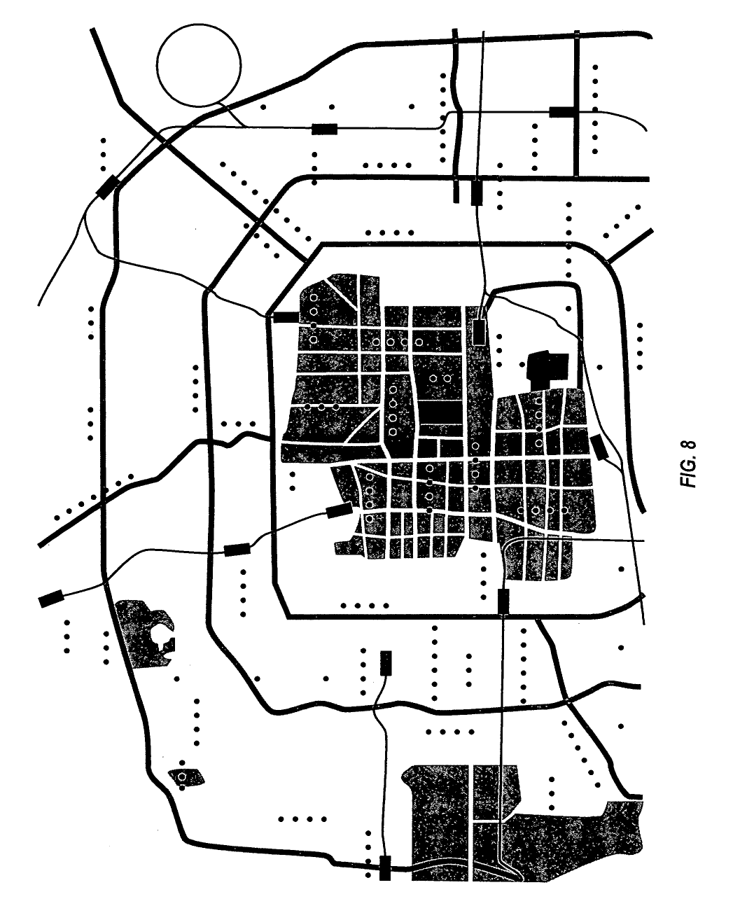

FIG. 8 is an explanatory diagram for the case of using the navigation system according to the embodiment of the present invention as car navigation equipment. Actual download time necessary to display the detailed map information shown in FIG. 8 on the client terminal 3 was measured. Although the diagram shows the map information in monochrome for illustrative purposes, a size of the actual bright color image of the map information is approximately 48 k bytes. When the image was downloaded with the client terminal that the XOE 30 was not loaded onto, it took approximately 40 second with a baud rate of 9.6 kbps. In contrast, it took only approximately one half of the time to download the image with the client terminal 3 loaded with the XOE 30.

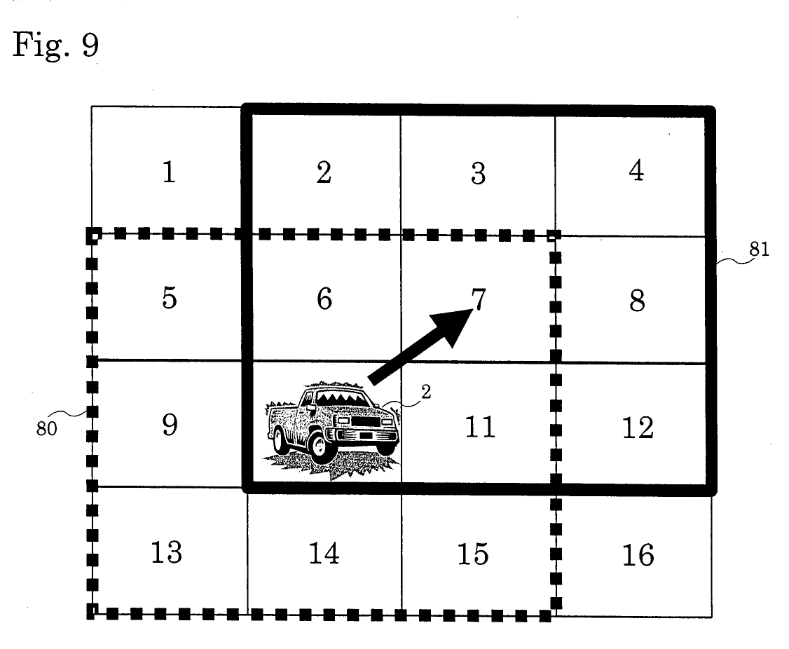

FIG. 9 is a diagram showing a moving direction of the mobile object 2 shown in FIG. 8. As shown in the diagram, when the mobile object 2 is in the area A, the navigation information 80 of the mobile object 2 in the area A is transmitted through the content server 1. Then, when the mobile object 2 moves to the area B, the navigation information 81 of the mobile object 2 in the area B will be transmitted through the content server 1. In this case, the client terminal 3 loaded with the XOE 30 downloads necessary map data in real time from the content server 1 with the movement of the mobile object 2.

In particular, when the mobile object 2 has moved from the position 10 to the position 7 in FIG. 9, the client terminal 3 loaded with the XOE 30 downloads only the map data on adjacent blocks. In FIG. 9, only the data on five blocks 2, 3, 4, 8 and 12 are read whereas the map data on unadjacent blocks 5, 9, 13, 14 and 15 are cleared at the right time. These processes are effectively carried out with a data synchronizing function and the package management function of the XOE 30.

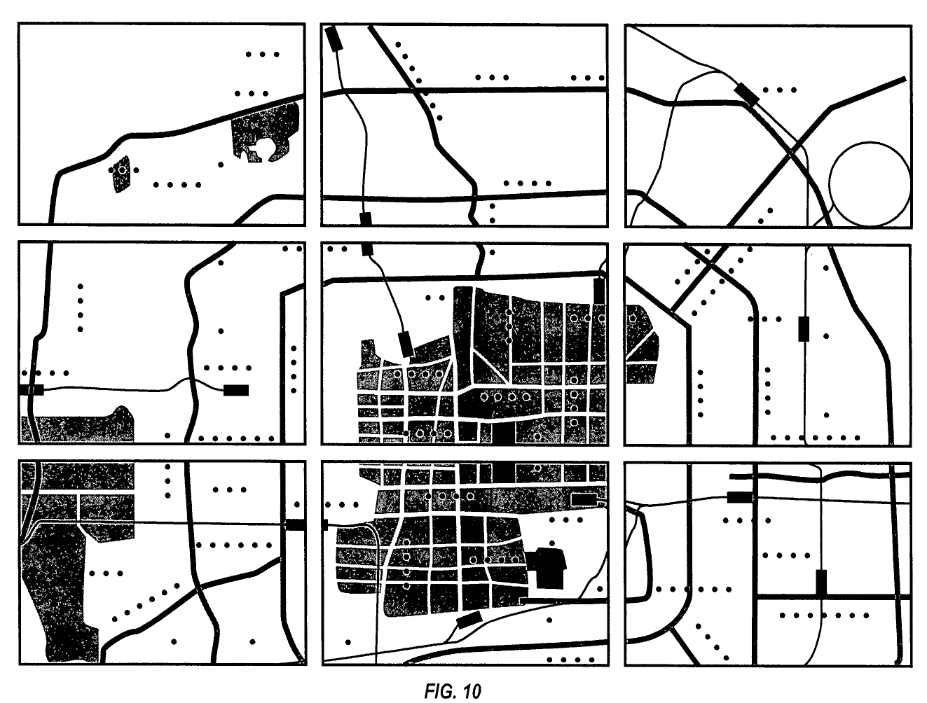

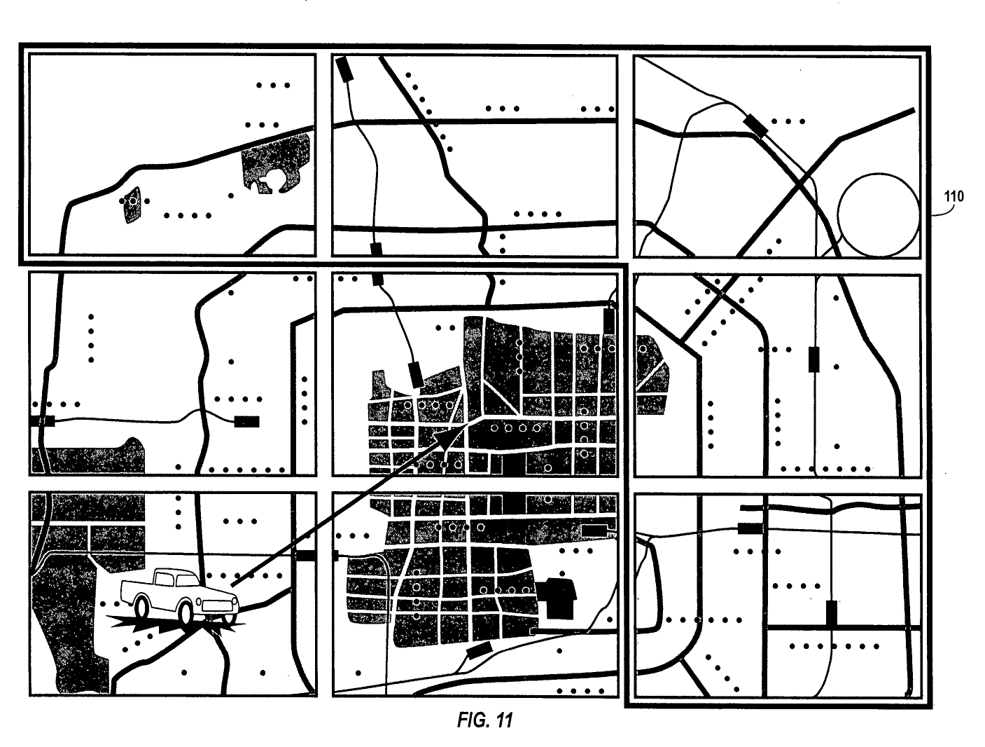

FIG. 10 is a diagram for describing a navigation process for the moving direction of the mobile object 2 shown in FIG. 9. In FIG. 10, the map is divided into nine blocks, each one of which has a size of approximately 6 k bytes. When the mobile object 2 has moved as shown in FIG. 11, the XOE 30 reads map data 110 on the five blocks shown in the diagram. The downloaded map data has a size of approximately 30 k bytes and it took approximately 25 seconds to complete the download with a baud rate of 9.6 kbps.

In the case of displaying a 9 km square map, i.e. 3 km on a side of one block, the mobile object has to move at 432 km/h to pass through one block before completion of the download, and hence it is clear that the download time is sufficiently small. When a calculation for the case of displaying a 3 km square map is made in a similar manner, the navigation process can follow a moving speed of the mobile object even when the mobile object moves at 144 km/h or less. Because map data being utilized in an actual car navigation system are much more compact in size due to the use of vector data, position information can be predicted and displayed well in advance.

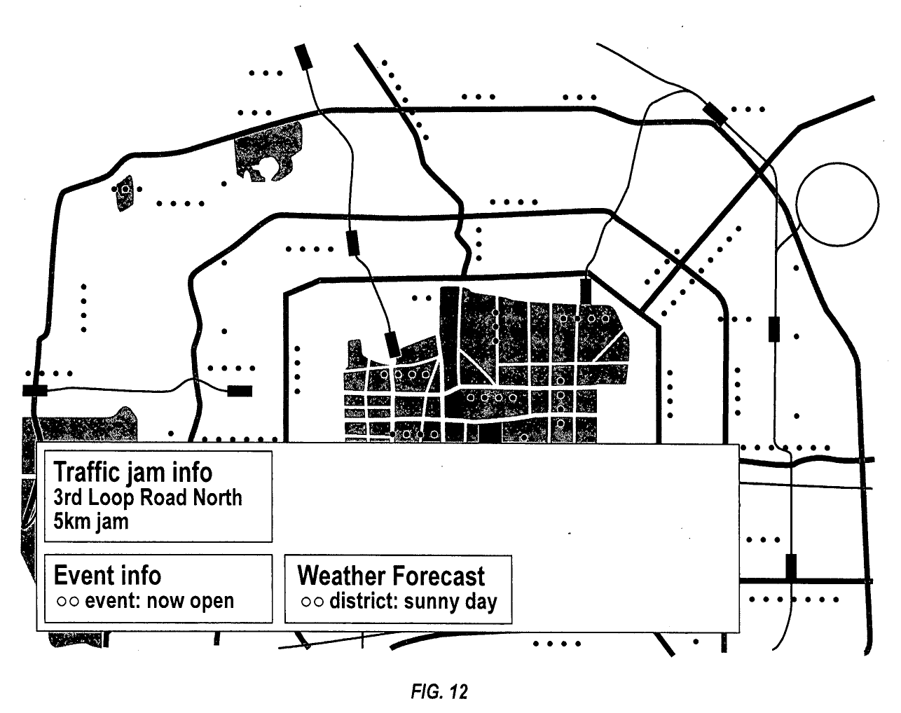

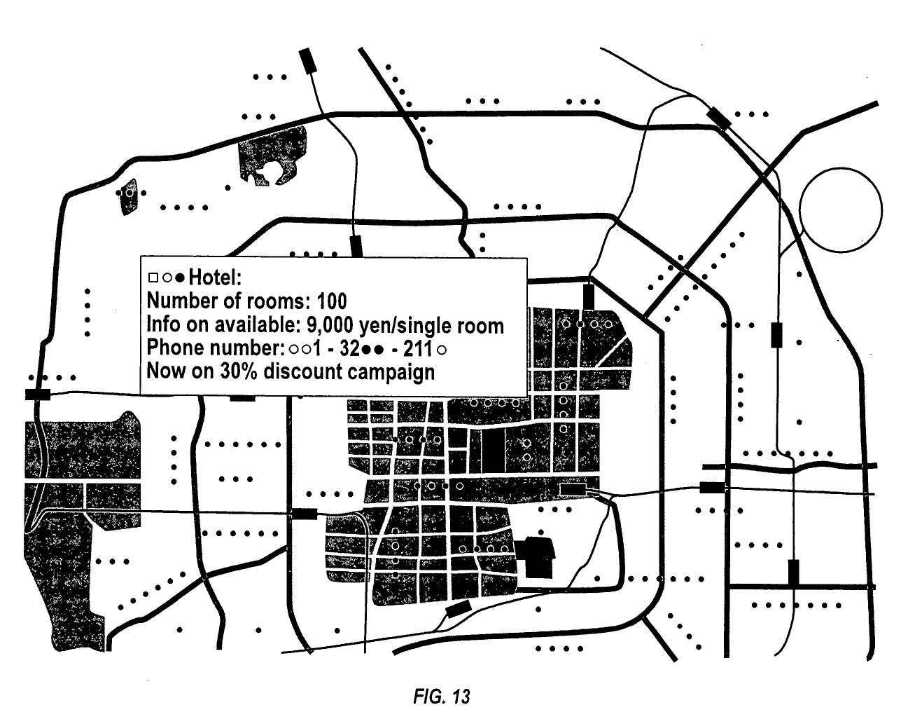

FIG. 12 is a third diagram for describing a navigation process for the moving direction of the mobile object 2 shown in FIG. 9. Traffic information and the like as shown in the diagram can be downloaded and displayed with the package management function of the XOE 30. In the diagram, traffic jam information, event information and weather information are displayed over map information. These kinds of information were downloaded from the map information database 60, the traffic information database 61, the weather information database 65 and the event information database 67 of the database 7 through the content server 1. FIG. 13 shows that when a user of the client terminal 3 requests accommodation information besides these kinds of information, the user can download appropriate information from the accommodation information database 64 based on the information the user input. Further as shown in the diagram, information on room availability and discount information such as a 30% discount campaign are displayed.

The present invention is not limited to the above-described embodiment, and various modifications and applications are possible. For example, a system configuration and a screen configuration may be appropriately changed. A procedure and the like may also be appropriately changed as long as the identical functions to the above can be substantially realized.

It is also understood that the examples and embodiments described herein are for illustrative purposes only and that various modifications or changes in light thereof will be suggested to persons skilled in the art and are to be included within the spirit and purview of this application and scope of the appended claims.

What is claimed is:

1. A navigation system comprising:
a navigation terminal for downloading and displaying information, the navigation terminal comprising:
a receiving device for receiving delivered information;
a processing device for processing the received information using an application loaded on the navigation terminal;
a display device for displaying processed information; and
transmitting device for transmitting position information of the navigation terminal to the information receiving device when the navigation terminal has moved; and
a server for transmitting content generated based on position information of the navigation terminal to the navigation terminal, the server comprising:
information receiving device for receiving an input of the position information from the navigation terminal through a network;
moving direction prediction device for predicting the succeeding moving direction of the navigation terminal based on the input position information;
map information generating device for generating map information based on the predicted information; and
information delivery device for delivering the generated map information through the network.

2. The navigation system according to claim 1, wherein the processing device comprises:
data synchronizing device for synchronizing data to be delivered from the information delivery device with the receiving device of the navigation terminal; and
package management device for executing a plurality of preset functions without the use of software on a platform, and the plurality of functions are executed after downloading the received information to be processed by the processing device whenever position information of the navigation terminal changes.

3. The navigation system according to claim 2, wherein the package management device downloads information to execute an appropriate function from the server at the request of a new service and then installs an application capable of providing the new service on the navigation terminal.

4. The navigation system according to claim 2, wherein the package management device downloads information to execute an appropriate function from the server at the request of a new service and then installs an application capable of providing the new service on the navigation terminal.

5. The navigation system according to claim 4, wherein the server comprises a database storing a plurality of applications to be sent to the navigation terminal upon the request of the navigation terminal.

6. The navigation system according to claim 4, wherein the moving direction prediction device divides adjacent map information into a plurality of blocks based on the information that the information receiving device has received and the processing device of the navigation terminal downloads only information on blocks in a moving direction of the navigation terminal.

7. The navigation system according to claim 6, wherein the moving direction prediction device divides adjacent map information into nine blocks and the processing device of the navigation terminal downloads only information on five blocks in the moving direction of the navigation terminal.

8. The navigation system according to claim 1, wherein the downloading and displaying by the navigation terminal is performed without downloading information stored on a CD-ROM device, a DVD-ROM device, or a hard disc device to the navigation terminal.

9. The navigation system according to claim 1, wherein the navigation system is equipped on a vehicle.

10. The navigation system according to claim 9 further comprising a security device for alerting at least one of an owner of the vehicle, law enforcement authority, and third party when the vehicle is stolen.

11. The navigation system according to claim 10, wherein the navigation terminal is configured to execute an emergency program when the vehicle is stolen, and the server is configured to predict vehicle movement direction by the moving direction prediction device based on position information of the navigation terminal.

12. The navigation system according to claim 1, wherein the downloading by the navigation terminal is of information stored on at least one of a flash memory, RAM, and ROM.

13. A navigation system comprised of a navigation terminal for downloading and displaying information and a server for transmitting content generated based on position information of the navigation terminal to the navigation terminal,
wherein the server comprises: information receiving means for receiving an input of the position information from the navigation terminal through a network; moving direction prediction means for predicting the succeeding moving direction of the navigation terminal based on the input position information; map information generating means for generating map information based on the predicted information; and information delivery means for delivering the generated map information through the network,
the navigation terminal comprises: receiving means for receiving the delivered information; processing means for processing the received information using an application loaded on the navigation terminal; display means for displaying the processed information; and transmitting means for transmitting the position information of the navigation terminal to the information receiving means when the navigation terminal has moved, and
the processing means comprises: data synchronizing means for synchronizing data to be delivered from the information delivery means with the receiving means of the navigation terminal; and package management means for executing a plurality of preset functions without the use of software on a platform, and the plurality of functions are executed after downloading the received information to be processed by the processing means whenever position information of the navigation terminal changes.

14. The navigation system according to claim 13, wherein information generated by the map information generating means includes information on traffic, restaurant, accommodation, shop, weather, parking and news in addition to the map information.

15. The navigation system according to claim 13, wherein the package management means downloads information to execute an appropriate function from the server at the request of a new service and then installs an application capable of providing the new service on the navigation terminal.

16. The navigation system according to claim 15, wherein the server comprises a database storing a plurality of applications to be sent to the navigation terminal upon the request of the navigation terminal.

17. The navigation system according to claim 15, wherein the moving direction prediction means divides adjacent map information into a plurality of blocks based on the information that the information receiving means has received and the processing means of the navigation terminal downloads only information on blocks in a moving direction of the navigation terminal.

18. The navigation system according to claim 17, wherein the moving direction prediction means divides adjacent map information into nine blocks and the processing means of the navigation terminal downloads only information on five blocks in the moving direction of the navigation terminal.

19. The navigation system according to claim 13, wherein none of a CD-ROM device, a DVD-ROM device and a hard disc device is loaded into the navigation terminal.

20. The navigation system according to claim 13, wherein in case that a vehicle equipped with the navigation terminal is stolen, the navigation terminal executes an emergency program and the server predicts the succeeding moving direction by the moving direction prediction means based on position information of the navigation terminal and comprises security means for alerting the police.
